(19) United States
(12) Patent Application Publication
(10) Pub. No.: US 2006/0277243 A1
(43) Pub. Date: Dec. 7, 2006

(54) Alternate representation of integers for efficient implementation of addition of a sequence of multiprecision integers

(75) Inventors: Claude Basso, Raleigh, NC (US); Jean L. Calvignac, Raleigh, NC (US); Natarajan Vaidhyanathan, Carrboro, NC (US); Fabrice J. Verplanken, La Gaude (FR)

Correspondence Address: DRIGGS, HOGG & FRY CO. L.P.A., 38500 CHARDON ROAD, DEPT. IRA, WILLOUGBY HILLS, OH, 44094, US

(73) Assignee: International Business Machines Corporation, Armonk, NY (US)

(21) Appl. No.: 11/142,937

(22) Filed: Jun. 2, 2005

(51) Int. Cl. G06F 7/38

(52) U.S. Cl. 708/524

(57) ABSTRACT

A technique for summing a series of integers of the form iᵢ+i₂+i₃+ . . . iₙ includes calculating the vector sum of the integers and a vector carry indicative of overflows resulting from generation of the vector sum. The vector sum and vector carry are used to calculate the sum of the addends.

### FIELD OF THE INVENTION

The present invention is directed to the field of single instruction stream, multiple data stream (SIMD) or vector processors. It finds particular application to cryptography, digital image processing and other applications where it is necessary to sum long strings of integers.

### BACKGROUND OF THE INVENTION

SIMD or vector processors are a class of parallel computer processors which apply the same instruction stream to multiple streams of data. For certain classes of problems, such as data-parallel problems, the SIMD architecture is well suited to achieve high processing rates, as the data can be split into many independent pieces and be operated on concurrently.

SIMD processors typically operate on data vectors, with each vector containing a plurality of components. In one example, a SIMD architecture may support 128 bit data vectors, with each vector containing four (4) thirty two (32) bit components.

FIG. 1 depicts a typical vector addition operation for an exemplary data vector containing p components. The vector addition operation yields a vector result of the form:
Sₚ=iₐₚ+i_{bp} Eq. 1
where iₐ and i_{b} are the addends and S is the sum. Typically, however, SIMD processors treat each of the sums Sₚ as distinct results. Thus, they do not typically detect an overflow or set a carry flag associated with the sums Sₚ, nor do they include an add with carry instruction.

SIMD processors have been used to sum addends which are multi-precision integers, for example a 128 bit unsigned integer. In these applications, it has been necessary to detect overflows and propagate the carries associated with each of the components to arrive at the sum. A technique for the addition of two 128-bit integers using a SIMD processor operating on a 128 bit data vector with four (4) thirty two (32) bit components is illustrated below:

```
#define full_add(ia, ib, ooc, oos)
{
vector unsigned int os,oc,oc1;
  os = vec_add(ia, ib);
  oc = vec_cmpgt(ia, os);
  oc1 = vec_and(oc, 1);
  oc = vec_slqwbyte(oc1, 4);
  os = vec_add(os, oc);
  oc = vec_cmpgt(oc, os);
  oc = vec_and(oc,1);
  oc1 = vec_or(oc1, oc);
  oc = vec_slqwbyte(oc, 4);
  os = vec_add(os, oc);
  oc = vec_cmpgt(oc, os);
  oc = vec_and(oc,1);
  oc1 = vec_or(oc1,oc);
  oc = vec_slqwbyte(oc, 4);
  oos = vec_add(os, oc);
  oc = vec_cmpgt(oc, oos);
  oc = vec_and(oc,1);
  oc1 = vec_or(oc1,oc);
  ooc = vec_rlmaskqwbyte(oc1, 20);
}
```

In some applications, for example in cryptography and digital image processing, it is necessary to perform long strings of additions of the form S=i₁+i₂+i₃+ . . . i_{N}, where each i is a multi-precision integer. Additions of this form have been carried out using N−1 addition operations as described above. Thus, each addition operation has included an overflow detection and carry propagation to arrive at an intermediate integer result. The intermediate result has been added to the next addend, and the process has been repeated until all N addends have been summed.

Detecting the overflows and propagating the carries in connection with each addition operation result in significant overhead, thus having a deleterious effect on processing time. Assuming that the addition of each addend i and associated overflow detection requires L instructions and the carry propagation requires M instructions, then the summation of N integers requires
(L+M)·(N−1) Eq. 2
operations. It is desirable to increase efficiency of and reduce the processing time required to perform such operations, especially when adding long strings of numbers.

Aspects of the present invention address these matters, and others.

### SUMMARY OF THE INVENTION

According to a first aspect of the present invention, a method of summing at least three integer addends using a SIMD processor includes the steps of generating a vector sum of the at least three addends, generating a vector carry indicative of overflows resulting from the generation of the vector sum of the at least three addends, and using the vector sum and the vector carry to calculate the sum of the at least three addends.

According to a more limited aspect of the present invention the vector sum S is equal to

$$S = {\sum }_{n = 1}^{N} vector\_add ( {S}_{n - 1} , {i}_{n} ) ,$$

where iₙ is an addend, and N is the number of addends being summed.

According to a still more limited aspect of the invention, vector carry C is equal to

$$C = {\sum }_{n = 1}^{N} vector\_add ( {C}_{n - 1} , {C}_{n} ) ,$$

where Cₙ is an intermediate vector carry.

According to a still more limited aspect, the step of using the vector sum and the vector carry to calculate the sum includes propagating the vector carry through the vector sum to generate an integer result.

According to another more limited aspect of the invention, the integer addends are summed in approximately L·N instructions, where L is the number of instructions required to calculate each Sₙ and Cₙ.

The step of generating a vector carry may include performing a plurality of vector subtractions.

According to another limited aspect of the invention, the step of generating a vector sum includes performing a plurality of vector additions.

According to another more limited aspect of the invention, the step of generating a vector carry includes generating an intermediate vector carry resulting from each vector addition, and accumulating the intermediate vector carries.

According to another more limited aspect, the step of using the vector sum and vector carry to calculate the sum includes propagating the vector carry through the vector sum to arrive at an integer result.

According to yet another more limited aspect, the addends are unsigned multiple precision integers.

According to another aspect of the present invention, a method of summing at least three unsigned integer addends includes the steps of accumulating the corresponding components of the integer addends to arrive at a vector sum, accumulating the carries resulting from the accumulation of the corresponding components of the integer addends to arrive at a vector carry, and propagating the vector carry through the vector sum to arrive at an integer result. The components of each addend are accumulated concurrently, and each addend is represented as a data vector comprising a plurality of components.

The step of accumulating the corresponding components of the integer addends may include performing a plurality of vector additions. A SIMD processor may be used to perform the plurality of vector additions.

According to a still more limited aspect of the invention, a vector carry C is equal to

$$C = {\sum }_{n = 1}^{N} vector\_subtract ( {C}_{n - 1} , - {C}_{n} ) ,$$

where Cₙ is an intermediate vector carry and N is the number of addends.

According to another aspect of the present invention, a computer-readable storage medium contains a set of instructions which, when executed by SIMD processor, carry out a method which includes generating a vector sum of at least three integer addends, generating a vector carry indicative of overflows arising during generation of the vector sum of the at least three integer addends, and propagating the vector carry through the vector sum to generate an integer sum of the at least three addends.

According to a more limited aspect of the invention, the step of generating a vector sum includes performing a plurality of vector additions. The method further includes detecting overflows resulting from the vector additions.

The step of generating a vector carry may include setting a component of Cₙ to 1 and performing a vector addition.

The step of generating a vector carry may include setting a component of Cₙ to −1 and performing a vector subtraction.

According to another more limited aspect of the invention, the step of generating a vector sum includes performing a plurality of vector additions and accumulating the results of the vector additions.

According to a still more limited aspect, the step of generating a vector carry includes generating intermediate vector carries based on the results of the vector additions and accumulating the intermediate vector carries.

According to another more limited aspect of the invention, the integer sum is generated in approximately L·N instructions. According to a yet more limited aspect, L equals 3.

Still other aspects and advantages of the present invention will be understood by those skilled in the art upon reading and understanding the attached description.

### DRAWINGS

The present invention will now be described with specific reference to the drawings in which:

FIG. 1 depicts a typical prior art vector addition operation.

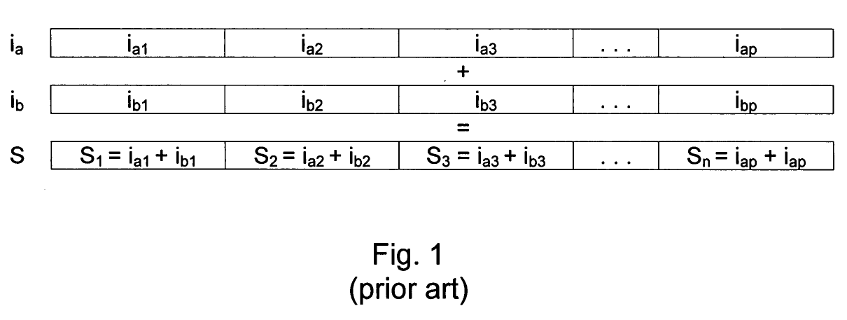

FIG. 2 depicts the addition of a series of integers using a SIMD processor.

### DETAILED DESCRIPTION OF THE INVENTION

A SIMD processor may be used to sum a series of n multi-precision integers of the form iᵢ+i₂+i₃+ . . . iₙ by generating a vector sum S and vector carry C equal to:

$$\begin{matrix}S = {\sum }_{n = 1}^{N} vector\_add ( {S}_{n - 1} , {i}_{n} ) & Eq . 3 \\ C = {\sum }_{n = 1}^{N} vector\_add ( {C}_{n - 1} , {C}_{n} ) & Eq . 4\end{matrix}$$

where S is the vector sum of the addends, C is the vector carry indicative of overflows occurring during generation of the vector sum, iₙ is the input addend, and N is the number of addends to be added.

Each intermediate vector carry Cₙ is determined by detecting the overflow, if any, resulting from the addition of each component of the data vector. This may be accomplished by performing a vector compare in which the value of each component of the sum Sₙ is compared to the value of the corresponding component of the input addend iₙ.

If the value of component of Sₙ is less than the value of the corresponding component of iₙ, then an overflow has occurred and the corresponding component of Cₙ is set to 1. If not, then there has been no overflow, and the corresponding component of Cₙ is set to 0. The vector carry C is accumulated, and the result of Equation 4 is achieved, through the use of a vector addition operation.

Another technique takes advantage of vector compare instructions which return a value of −1 if the result is true, or 0 if the result is false. If the value of a component of iₙ is greater than the value of a corresponding component of Sₙ, then an overflow has occurred, and the corresponding component of Cₙ is set to −1, or −Cₙ. In this example, the vector carry C is accumulated, and the result of Equation 4 is achieved, through the use of a vector subtract operation. Thus, the vector carry C may alternately be expressed as

$$C = {\sum }_{n = 1}^{N} vector\_subtract ( {C}_{n - 1} , - {C}_{n} ) . \qquad Eq . 5$$

The vector carry C and the vector sum S are used to calculate the sum of the addends, for example by propagating the vector carry C through the vector sum S to arrive at an integer result. As will be appreciated, the overhead associated with propagating the carry is amortized over the series of N additions. Assuming that the calculation of each Sₙ and Cₙ requires L instructions and that the propagation of the carry requires M instructions, then N integers may be summed in
L·(N−1)+M Eq. 6
instructions. As N becomes large, then the number of instructions required to complete the summation becomes approximately
L·N Eq. 7
instructions.

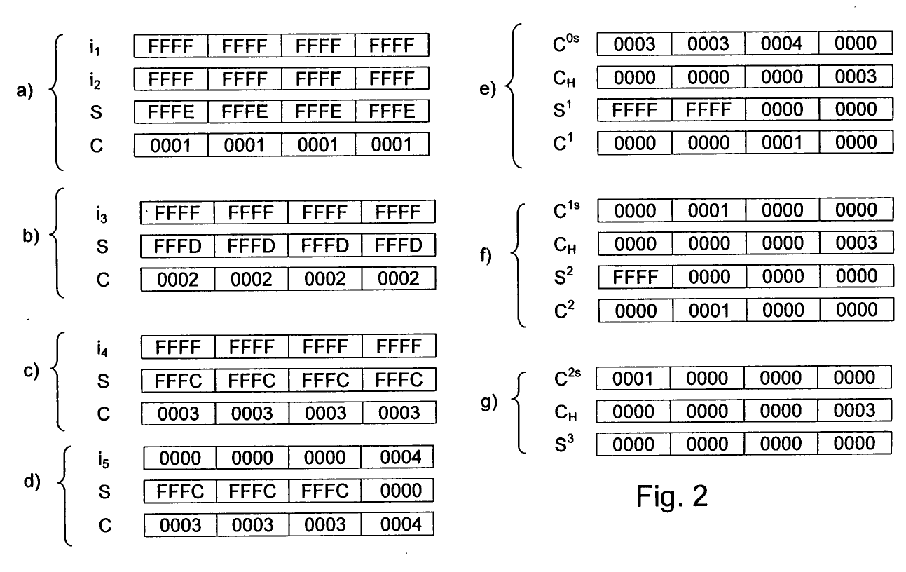

An exemplary summation of N=5 integers will be further explained with reference to FIG. 2. In the example, the processor operates on a 128 bit data vector having four (4) thirty two (32) bit components. The input addends iₙ are 128 bit unsigned integers.

With reference to FIG. 2a, a vector addition is performed on addends i₁ and i₂ to arrive at a vector sum S. The overflows associated with the vector addition are detected lo and used to generate an intermediate vector carry Cₙ. The intermediate vector carries are accumulated as vector carry C. With reference to FIGS. 2b through 2f, this process is repeated for each of the addends. In particular, the results of each vector addition are accumulated as vector sum S and the carries are accumulated as vector carry C.

Turning now to FIGS. 2e through 2f, vector carry C is propagated through the vector sum S to arrive at an integer sum. With reference to FIG. 2e, vector carry C is shifted left by one word to generate partial shifted carry C^{0s}, and C_{H} represents the topmost word of carry C. Partial result S¹ is generated by determining the vector sum of S and C^{0s}, and overflows associated with the operation are detected to generate partial vector carry C¹.

With reference to FIG. 2f, partial vector carry C¹ is shifted left by one word to generate shifted partial carry C^{1s}, and carry C_{H} is retained. Partial result S² is generated by determining the vector sum of S¹ and C^{1s}, and overflows associated with the vector sum are detected to generate partial vector carry C².

With reference to FIG. 2g, partial vector carry C² is shifted left by one word to generate shifted partial carry C^{2s}. Partial result S³ is generated by determining the vector sum of S² and C^{2s}. As will be appreciated, C_{H} represents the most significant and S³ represents the least significant bits of the unsigned integer resulting from the summation of the addends.

An exemplary summation of sixteen (16) 128-bit integers x₁+x₂+x₃+ . . . x₁₆ is illustrated below. In the example, each data vector contains four (4) thirty-two (32) bit unsigned integer words.

```
first_part_add(x1, x2, c, s);
  part_add(x3, s, c, c, s);
  part_add(x4, s, c, c, s);
  ....
  ....
  part_add(x16, s, c, c, s);
  c1 = vec_rlmaskqwbyte(c, 20);
  c = vec_slqwbyte(c,4);
  full_add_fast(c, s, c, s);
  c = vec_add(c1, c);
#define part_add(in_a, in_s, in_c, out_c, out_s)
{
vector unsigned int c0;
out_s = vec_add(in_s, in_a);
c0 = vec_cmpgt(in_a, out_s);
out_c = vec_sub(in_c, c0);
}
#define first_part_add(in_a, in_b, out_c, out_s)
{
out_s = vec_add(in_a, in_b);
out_c = vec_cmpgt(in_a, out_s);
out_c = vec_and(out_c, 1);
}
#define full_add_fast(ia, ib, ooc, oos)
{
vector unsigned int os,oc,oc1;
  os = vec_add(ia, ib);
  oc1 = vec_cmpgt(ia, os);
  oc = vec_slqwbyte(oc1, 4);
  os = vec_sub(os, oc);
  oc = vec_cmpgt(oc, os);
  oc1 = vec_or(oc1, oc);
  oc = vec_slqwbyte(oc, 4);
  os = vec_sub(os, oc);
  oc = vec_cmpgt(oc, os);
  oc1 = vec_or(oc1,oc);
  oc = vec_slqwbyte(oc, 4);
  oos = vec_sub(os, oc);
  oc = vec_cmpgt(oc, oos);
  oc1 = vec_or(oc1,oc);
  ooc = vec_rlmaskqwbyte(oc1, 20);
  ooc = vec_and(ooc, 1);
}
```

In the above example, L=3, and M=19, and N=16. Accordingly, the overflow detection and carry handling overhead is amortized over 15 addition operations, and the summation would require L·(N−1)+M or 64 instructions. As N becomes large, the number of instructions required to perform the summation approaches L·N instructions.

The first_part_add function described above assumes that the components of out_s are not equal to the components of in_a, i.e. that the components of in_b are non-zero. If, in a given application, this condition may not be satisfied, the function can readily be modified to test for it.

The functions described above take advantage of the fact that the vector compare instruction returns a value of 0×FF (−1) if the result is true and 0×00 if the result is false. Thus, the carry may be accumulated by subtracting 0×FF (−1) or 0×00 rather than adding 0 or 1 for each component. Techniques other than the full_add_fast function can also be used to perform the overflow detection and carry propagation. For example, the full_add function described in the background section of the present specification could also be used.

The summation is also not limited to processor architectures having 128 bit data vectors or operating on four (4) thirty-two (32) bit data components. Thus, the summation may readily be implemented on processor architectures having data vectors of arbitrary length or containing an arbitrary number of components. Moreover, the summation is not limited to N=5 or 16. Thus, the summation may readily be performed on an arbitrary number of addends.

Care should be taken in the case where N is large enough that the accumulated components in the vector carry could themselves overflow. In the case of an exemplary processor having a 128 bit data vector operating on four (4) thirty two (32) bit components, no such pointwise carries can be generated as long as the number of addends N is less than or equal to 2³²−1. Stated more generally, no pointwise carries can be generated in the vector carry C as long as N is less than or equal to 2^{P}−1, where P is the width of the components in the data vector. In that case, it is not necessary to check for pointwise carries. Where P is larger, however, it is possible to detect such overflows and store the corresponding carries as components of an additional data vector. The results could then be propagated through the vector sum to arrive at the result.

Alternatively, it is possible to limit the number of addends so that such overflows do not occur. Where one or more of the intermediate results are of interest, it is also possible to perform a series of partial summations. In either case, the summation could then be performed as a series of piecewise partial summations as described above, with each summation generating an intermediate result, some or all of which could be saved or otherwise be acted upon. The intermediate results would then be summed to arrive at the final result.

Of course, those skilled in the art will also recognize that the summation is not limited to a particular model or vendor of SIMD processor. Thus, for example, the technique may be using processors having varying register and memory architectures. Those skilled in the art will recognize that the storage and handling of the addends, vector sums, vector carries, intermediate results, and other relevant information can readily be implemented based on such architectures, the processor specific instruction set, the number of addends, the requirements of the particular application, and the like.

The instructions used to carry out the techniques can be embodied in a computer software program or directly into a computer's hardware. Thus, the instructions may be stored in computer readable storage media, such as non-alterable or alterable read only memory (ROM), random access memory (RAM), alterable or non alterable compact disks, DVD, on a remote computer and conveyed to the host system by a communications medium such as the internet, phone lines, wireless communications, or the like.

The invention has been described with reference to the preferred embodiments. Of course, modifications and alterations will occur to others upon reading and understanding the preceding description. It is intended that the invention be construed as including all such modifications and alterations insofar as they come within the scope of the appended claims or the equivalents thereof.

What is claimed is:

1. A method of summing at least three integer addends using a SIMD processor, the method comprising:
generating a vector sum of the at least three addends;
generating a vector carry indicative of overflows resulting from the generation of the vector sum of the at least three addends; and
using the vector sum and the vector carry to calculate the sum of the at least three addends.

2. The method of claim 1 wherein
$$S = {\sum }_{n = 1}^{N} vector\_add ( {S}_{n - 1} , {i}_{n} ) ,$$
where S is the vector sum, in, is an addend, and N is the number of addends being summed.

3. The method of claim 2 wherein
$$C = {\sum }_{n = 1}^{N} vector\_add ( {C}_{n - 1} , {C}_{n} ) ,$$
where C is the vector carry and Cₙ is an intermediate vector carry.

4. The method of claim 3 wherein the step of using the vector sum and the vector carry to calculate the sum includes propagating the vector carry through the vector sum to generate an integer result.

5. The method of claim 4 wherein the integer addends are summed in approximately L·N instructions, where L is the number of instructions required to calculate each Sₙ and Cₙ.

6. The method of claim 3 wherein the step of generating a vector carry includes performing a plurality of vector subtractions.

7. The method of claim 1 wherein the step of generating a vector sum includes performing a plurality of vector additions.

8. The method of claim 7 wherein the step of generating a vector carry includes
generating an intermediate vector carry resulting from each vector addition;
accumulating the intermediate vector carries.

9. The method of claim 1 wherein the step of using the vector sum and vector carry to calculate the sum includes propagating the vector carry through the vector sum to arrive at an integer result.

10. The method of claim 1 wherein the addends are unsigned multiple precision integers.

11. A method of summing at least three unsigned integer addends, each addend being represented as a data vector comprising a plurality of components, the method comprising:
accumulating the corresponding components of the integer addends to arrive at a vector sum, wherein the components of each addend are accumulated concurrently;
accumulating the carries resulting from the accumulation of the corresponding components of the integer addends to arrive at a vector carry;
propagating the vector carry through the vector sum to arrive at an integer result.

12. The method of claim 11 wherein the step of accumulating the corresponding components of the integer addends comprises performing a plurality of vector additions.

13. The method of claim 12 further comprising using a SIME processor to perform the plurality of vector additions.

14. The method of claim 11 wherein
$$S = {\sum }_{n = 1}^{N} vector\_add ( {S}_{n - 1} , {i}_{n} ) ,$$
where S is the vector sum and iₙ is an input addend.

15. The method of claim 11 wherein
$$C = {\sum }_{n = 1}^{N} vector\_subtract ( {C}_{n - 1} , - {C}_{n} ) ,$$
where C is the vector carry, Cₙ is an intermediate vector carry and N is the number of addends.

16. A computer-readable storage medium containing a set of instructions which, when executed by SIMD processor, carry out a method comprising the steps of:
generating a vector sum of at least three integer addends;
generating a vector carry indicative of overflows arising during generation of the vector sum of the at least three integer addends; and
propagating the vector carry through the vector sum to generate an integer sum of the at least three addends.

17. The computer readable storage medium of claim 16 wherein the step of generating a vector sum comprises performing a plurality of vector additions, and wherein the method further includes detecting overflows resulting from the vector additions.

18. The computer readable storage medium of claim 16 wherein
$$C = {\sum }_{n = 1}^{N} vector\_add ( {C}_{n - 1} , {C}_{n} ) ,$$
where C is the vector carry and Cₙ is an intermediate vector carry.

19. The computer readable storage medium of claim 18 wherein the step of generating a vector carry includes setting a component of Cₙ to 1 and performing a vector addition.

20. The computer readable storage medium of claim 18 wherein the step of generating a vector carry includes setting a component of Cₙ to −1 and performing a vector subtraction.

21. The computer readable storage medium of claim 16 wherein the step of generating a vector sum includes performing a plurality of vector additions and accumulating the results of the vector additions.

22. The computer readable storage medium of claim 21 wherein the step of generating a vector carry includes generating intermediate vector carries based on the results of the vector additions and accumulating the intermediate vector carries.

23. The computer readable storage medium of claim 16 wherein the integer sum is generated in approximately L·N instructions.

24. The computer readable storage medium of claim 23 wherein L equals 3.
